(19) United States
(12) Patent Application Publication
(10) Pub. No.: US 2019/0258044 A1
(43) Pub. Date: Aug. 22, 2019

(54) MICROSCOPE ILLUMINATION DEVICE AND MICROSCOPE HAVING SUCH A MICROSCOPE ILLUMINATION DEVICE

(71) Applicant: Leica Microsystems CMS GmbH, Wetzlar (DE)

(72) Inventor: Cornell Peter Gonschior, Friedberg (DE)

(21) Appl. No.: 16/311,692

(22) PCT Filed: Jun. 27, 2017
(86) PCT No.: PCT/EP2017/065786

§ 371 Date: Dec. 20, 2018

(30) Foreign Application Priority Data
Jun. 27, 2016 (DE) 10 2016 111 730.7

(51) Int. Cl. G02B 21/06; F21V 8/00

(52) U.S. Cl. CPC G02B 21/06; G02B 6/0003

(57) ABSTRACT

A microscope illumination device includes at least one light source and a light conversion element. The light conversion element is configured as at least one optical waveguide which contains different fluorescent materials each having different emission ranges. The at least one light source is arranged such that emission light for exciting the fluorescent materials from the at least one light source is coupled into the light conversion element. The light conversion element is configured such that light emitted by the fluorescent materials is guided to a light exit face of the light conversion element and is decoupled at the light exit face as illumination light.

### CROSS-REFERENCE TO PRIOR APPLICATIONS

This application is a U.S. National Stage Application under 35 U.S.C. § 371 of International Application No. PCT/EP2017/065786 filed on Jun. 27, 2017, and claims benefit to German Patent Application No. DE 10 2016 111 730.7 filed on Jun. 27, 2016. The International Application was published in German on Jan. 4, 2018, as WO 2018/002009 A1 under PCT Article 21(2).

### FIELD

The present invention relates to a microscope illumination device and a microscope having such a microscope illumination device.

### BACKGROUND

Semiconductor elements such as light-emitting diodes are frequently used for the illumination device of scientific and/or medical devices, such as microscopes, micro-dissection devices, endoscopes, etc. By combining several different light-emitting diodes which each emit light at different wavelength ranges, an illumination light with a white color impression may be generated.

For example, in DE 10 2010 067 786 A1, a microscope illumination is disclosed having at least one semiconductor light source and at least one light mixing element. In the light mixing element, light entering via a light entrance face is mixed in its interior. Mixed light exits the light mixing element at a light exit face. The semiconductor light sources are light-emitting diodes, for example. Several light-emitting diodes may be used—for example, to generate a white mixed light. Similar illumination devices are also described in the publications, U.S. Pat. Nos. 4,923,279 A1, 6,783,269 B2, 5,588,084 A1, and 7,898,665 B2, for example.

However, since individual light-emitting diodes usually have only a very narrowband emission spectrum, illuminating light generated by such light-emitting diodes is often not homogeneously white and usually has no broadband, continuous spectrum, but, rather, a juxtaposition of individual discrete or narrowband individual spectra. However, for scientific and/or medical devices, it may often be necessary to provide a homogeneous, white illumination light with a continuous, broadband spectrum, which is usually not possible with such conventional illumination devices.

US 2009/0034292 A1 shows an illumination device with at least one LED and with an optical waveguide which contains different wavelength conversion materials, each having different emission ranges. The wavelength conversion materials are irradiated by the LED, and the converted light is decoupled at a light exit face. The illumination device generates white light as backlighting for monitors.

### SUMMARY

In an embodiment, the present invention provides a microscope illumination device having at least one light source and a light conversion element. The light conversion element is configured as at least one optical waveguide which contains different fluorescent materials each having different emission ranges. The at least one light source is arranged such that emission light for exciting the fluorescent materials from the at least one light source is coupled into the light conversion element. The light conversion element is configured such that light emitted by the fluorescent materials is guided to a light exit face of the light conversion element and is decoupled at the light exit face as illumination light.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically shows a preferred embodiment of a microscope illumination device according to the invention, in a side view.

FIG. 2a and FIG. 2b schematically show preferred embodiments of a microscope illumination device according to the invention, respectively in a cross-section view.

FIG. 3 schematically shows spectra of fluorescent materials of a preferred embodiment of a microscope illumination device according to the invention.

FIG. 4 schematically shows a preferred embodiment of a microscope illumination device according to the invention, in a side view.

FIG. 5 schematically shows a preferred embodiment of a microscope according to the invention, with a preferred embodiment of a microscope illumination device according to the invention, in a side view.

### DETAILED DESCRIPTION

In an embodiment, the present invention provides an improved illumination device by means of which as homogeneous a white illumination light as possible, with as continuous a broadband, but variable, spectrum as possible, may be generated.

According to an embodiment, the illumination device of a microscope has at least one light source and one light conversion element. The at least one light source is embodied, in particular, as at least one semiconductor light source, or as at least one semiconductor element, e.g., as at least one light-emitting diode, and/or as at least one laser light source. The light conversion element is designed as at least one optical waveguide, which contains different fluorescent materials with different respective emission ranges.

The different fluorescent materials each have an excitation range or absorption range, wherein they each, expediently, absorb light having a wavelength in this excitation range. After such an excitation, the fluorescent materials emit emission light having wavelengths in the respective emission range. The individual materials may thereby each have the same excitation range or respective different excitation ranges. Thus, light may be generated inside the light conversion elements by the fluorescent materials.

The at least one light source is arranged in such a way that emission light for exciting the fluorescent materials from the at least one light source is coupled into the light conversion element. The emission light of the light sources, expediently, has a wavelength which lies in the excitation range of the fluorescent materials. The light conversion element is configured in such a way that light emitted by the fluorescent materials is directed to a light exit face of the light conversion element, and is there decoupled as illumination light.

In particular, the light conversion element is not made entirely of the fluorescent materials; rather, the materials are introduced into the light conversion element at suitable locations. The light conversion element, expediently, has the properties of a conventional optical waveguide. In particular, the light conversion element is transparent, so that emission light of the light sources may be radiated into the light conversion element in a simple manner. The emission light generated by the fluorescent materials is, expediently, guided within the light conversion element by reflection or total reflection.

The light conversion element may be composed of an optical waveguide or also of several optical waveguides, which, in particular, are arranged in succession or behind one another. These individual optical waveguides may, expediently, have the same, or at least essentially the same, shape. The composition of the individual optical waveguides—in particular, the density and the type of the fluorescent materials introduced therein—may be identical or may also be different.

A separation between the primary light sources and the generation of the illumination light is enabled via an embodiment of the invention. The light conversion element enables, in particular, a conversion of the emission light of the light sources into the illumination light. Characteristics of the illumination light are determined, in particular, by the properties of the fluorescent materials, and are, in particular, not dependent, or at least are barely dependent, upon characteristics of the light sources used. By suitable selection of the fluorescent materials, a homogeneous, white illumination light with a broadband, continuous spectrum is, expediently, provided.

Conventional illumination light sources, e.g., for microscopes or other scientific purposes, often use different light-emitting diodes or other semiconductor light sources whose light is mixed, in order to produce a white color impression. However, since individual light-emitting diodes usually have only a very narrowband emission spectrum, a combination of a plurality of different light-emitting diodes with respective different emission spectra is necessary, in order to generate illumination light with a white color impression. However, this illumination light is often not homogeneously white and usually has no broadband, continuous spectrum, but, rather, a juxtaposition of individual discrete or narrowband individual spectra. Furthermore, given such conventional illumination light sources, a plurality of different optical elements is often required, e.g., dichroic mirrors, which must be precisely adapted to the specific beam characteristics and arrangements of the light-emitting diodes. Such conventional illumination light sources are structurally very complex and require high precision in the alignment of optical elements.

In contrast to this, with the illumination light source according to an embodiment of the invention, homogeneous, white illumination light may be generated without any constructive effort and without the need for precisely-aligned optical elements. The individual fluorescent materials, expediently, each have a broadband emission spectrum. In particular, it is thus made possible to provide illumination light with a broadband spectrum, using light sources with a comparatively narrowband emission spectrum.

For example, it is thus not necessary to use a plurality of different light sources with different emission spectra. If the fluorescent materials each have the same or similar excitation ranges, light sources—particularly, light-emitting diodes—of the same type or having the same or similar emission spectra, for example, may be used, in order to excite all fluorescent materials in the light conversion element at the same time. Nevertheless, via the various emission ranges of the fluorescent materials, a broadband illumination light may be generated.

Furthermore, via the illumination light source, flexibly varying the spectral composition or the spectrum of the illumination light is made possible. In particular, individual spectral components of the illumination light can, flexibly, be switched on or off. For example, if different fluorescent materials each have different individual excitation ranges, to excite these individual materials, respective corresponding light sources with emission ranges specially adapted to these excitation ranges may be provided. Thus, the spectral composition of the illumination light can be varied in a simple, flexible manner by turning the respective light sources on or off.

The generated homogeneous, white illumination light, which represents a light having a very natural effect, is particularly suitable for illuminating objects to be observed in microscopes. However, the microscope illumination device is also suitable for use in other purposes—in particular, scientific and/or medical purposes—e.g., for micro-dissection devices, endoscopes, etc.

The light conversion element may, for example, be formed as a rod, fiber, disk, plate, etc. For example, the light conversion element may also have a core and a cladding, wherein light is guided within the core. The cladding thereby has, in particular, a lower refractive index than the core. In particular, the individual light sources are arranged on one or more sides of the light conversion element and illuminate this from the side. It is also conceivable, for example, that the light conversion element be repeatedly directed past the light sources in a spiral or wandering path.

The light sources are, expediently, arranged in one or more rows. In particular, at least two of the light sources are arranged next to one another in such a row. In particular, these rows are respectively arranged parallel to one another—for example, on opposite sides of the light conversion element.

The light sources arranged in such a row are, expediently, identical or structurally identical, or emit emission light of the same, or at least essentially the same, wavelength. If the different fluorescent materials each have different, individual excitation ranges, the individual rows may in each instance be provided for excitation of a specific material. Spectral components of the illumination light may thus be switched on or off in a simple manner by activating or deactivating corresponding rows of light sources.

The light conversion element, expediently, has a circular and/or elliptical and/or polygonal cross-sectional area. With a polygonal shape, the emission light of the light sources may be particularly effectively coupled to the corresponding flat side faces of the light conversion element. For example, the individual light sources may thereby also be arranged directly on these flat side faces.

In particular, the cross-sectional area of the light conversion elements has the shape of a polygon with rounded corners. A particularly effective intermixing of the light emitted by the individual fluorescent materials, for example, may be ensured, given such a shape of the cross-sectional area. Furthermore, oblique rays are suppressed, which, in particular, leads to a homogeneous illumination of the light exit face.

The at least one light source is, expediently, arranged on at least one active and/or passive cooling device. For example, a separate cooling device may be provided for each of the above-described rows of light sources.

A control device for controlling the light sources is preferably provided. This control device may, expediently, also be set up for controlling active cooling devices.

According to a preferred embodiment, the light conversion element is subdivided into segments. Each of these segments, advantageously, respectively contains only one of the fluorescent materials. Alternatively or additionally, each of these segments preferably respectively contains fluorescent materials having the same or at least essentially the same emission ranges. The light conversion element is thus subdivided into segments such that light is emitted in different emission ranges in each of these segments. In particular, a different proportion of the illumination light is thus generated in different wavelength ranges in each of these segments. In this way, a modular embodiment of the light conversion element may be enabled, as a result of which the flexible switching on or switching off of spectral portions of the illumination light is, expediently, enabled.

The individual segments may be realized by, for example, individual different optical waveguides which each contain the corresponding fluorescent materials. These individual optical waveguides may, as described above, be arranged in succession or behind one another.

The at least one light source advantageously has multiple light sources, of which respectively at least one is provided for each of the segments. In particular, the light sources which are associated with the same segments are arranged in one group. For example, the light sources of such a group may be arranged in rows, as explained above. The light sources of such a group respectively illuminate, in particular, only the corresponding segment and excite the corresponding fluorescent materials of the respective segment. In particular, the different groups of light sources may be activated or deactivated individually and independently of one another.

The segments are preferably each separated from one another by separating elements which respectively reflect or absorb light at specific wavelengths. These separating elements, expediently, respectively absorb or reflect emission light of the light sources. In particular, it may thus be prevented that light of the light sources or of the group of light sources which was not absorbed in the respective segment by the fluorescent materials there be guided further into adjacent segments and there possibly excite the fluorescent materials, although this corresponding segment is deactivated.

The light conversion element is advantageously formed as at least one transparent solid which contains the different fluorescent materials. For example, such a solid may be made of glass or plastic, such as acrylic glass (polymethyl methacrylate, PMMA). The different fluorescent materials may be introduced into such solid bodies in a simple, structurally low-cost manner. Furthermore, a simple coupling of the light of the light sources and an efficient light guidance within the solid may be ensured.

The different fluorescent materials preferably consist of quantum dots (QD). Quantum dots are nanoscopic material structures—in particular, made of semiconductor material (e.g., InGaAs, CdSe, InP, or GaInP). Charge carriers (electrons, holes) in a quantum dot are limited in their mobility such that their energy can no longer assume continuous values, but, rather, only discrete values, which is why quantum dots behave similarly to atoms. Shape, size, and number of electrons may be selected, expediently, so that electronic and optical properties of quantum dots can be flexibly adjusted. In contrast to atoms, emission spectra of individual quantum dots are not line spectra, but, rather, have, in particular, the form of a Lorentz curve. The emission spectrum of an ensemble of quantum dots has, in particular, the form of a Gaussian curve, since the superposition of individual spectral Lorentz curves at different emission wavelengths leads, in particular, to a Gaussian distribution.

The different emission ranges of the different fluorescent materials are, particularly preferably, respectively selected such that, if light is respectively emitted in all of these different emission ranges, homogeneous, or at least essentially homogeneous, white light is provided at the light exit face. The light conversion element, expediently, contains different fluorescent materials with, for example, at least three different emission ranges. A particularly homogeneous, white illumination light with a broadband spectrum may, expediently, be provided via such different emission ranges.

The emission light of the at least one light source advantageously has shorter wavelengths than the light emitted by the fluorescent materials. Accordingly, the fluorescent materials each have an absorption range at shorter wavelengths than their corresponding emission ranges. In particular, the light sources emit in the blue or UV range. This light is, expediently, converted by the light conversion elements into light in the visible range.

The emission light of the at least one light source preferably has wavelengths between 300 nm and 500 nm—preferably, between 350 nm and 450 nm. The different emission ranges of the different fluorescent materials are preferably at wavelengths between 400 nm and 700 nm—preferably, at wavelengths between 450 nm and 670 nm. For example, center wavelengths of the individual emission ranges of the fluorescent materials may be at 450 nm and/or 490 nm and/or 525 nm and/or 540 nm and/or 575 nm and/or 630 nm and/or 665 nm, respectively.

The fluorescent materials are, advantageously, arranged in the light conversion element such that a density and/or the emission ranges and/or excitation ranges of the fluorescent materials follow a predetermined distribution along a length of the light conversion element in the direction of the light exit face. In particular, the density decreases in the direction of the light exit face. In particular, the distributions of density and excitation and emission ranges are matched to each other so that secondary absorption (i.e., an absorption of the light emitted by the fluorescent materials) may be prevented, whereby the efficiency of the illumination light source may be increased.

A reflective element, e.g., a reflective coating, is, advantageously, arranged at an end, situated opposite the light exit face, of the light conversion element. If light in the light conversion element emitted by the fluorescent materials is guided to this end, it is reflected at the reflecting element in the direction of the light exit face and guided to said light exit face. At the light exit face, all, or at least substantially all, of the emission light generated in the light conversion element is thus, expediently, provided as illumination light.

In particular, the reflective element is configured to reflect light with wavelengths in the emission ranges of the fluorescent materials. The reflective element may, expediently, also be transparent at specific wavelength ranges—for example, at one or all excitation ranges of the fluorescent materials. It is therefore made possible that one or more of the light sources which emit light in this specific wavelength range are also arranged behind this end of the light conversion element.

A light-emitting element is, preferably, arranged at the light exit face of the light conversion element. By this light-emitting element, an effective emission or radiation of the illumination light, in particular, is ensured. For example, the light-emitting element may be designed as an anti-reflection element, e.g., an anti-reflection coating, and/or as a parabolic concentrator, and/or as a gradient index lens.

An embodiment of the invention furthermore relates to a microscope with a preferred embodiment of a microscope illumination device according to the invention. Analogously, advantages and preferred embodiments of the microscope according to the invention are apparent from the above description of the microscope illumination device according to embodiments of the invention.

Further advantages and embodiments of the invention are apparent from the description and the accompanying drawings.

It is to be understood that the features mentioned above and the features to be explained in detail below can be used not only in the respective indicated combination, but also in other combinations or alone, without departing from the scope of the present invention.

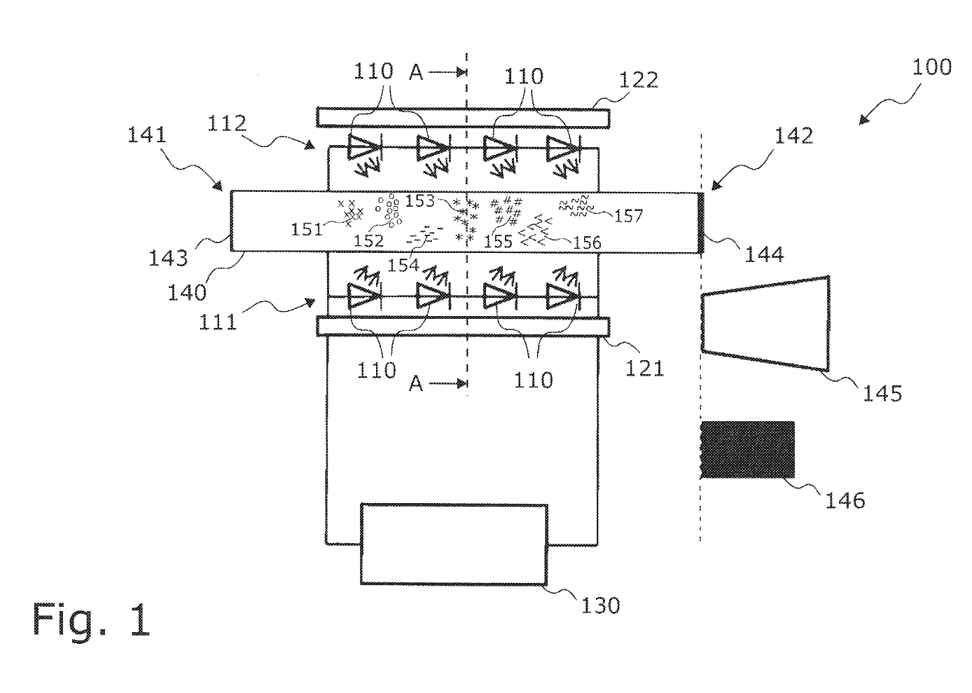

In FIG. 1, a preferred embodiment of a microscope illumination device according to the invention is schematically depicted in a side view and is designated with 100.

The microscope illumination device 100 has light sources 110 in the form of light-emitting diodes. In the example illustrated, four light-emitting diodes are respectively combined to form a group 111 or 112. The light-emitting diodes of each of these groups 111 and 112 are each arranged linearly, side-by-side in a row.

An active cooling device 121 or 122 is respectively provided for each of these groups 111 and 112 of light-emitting diodes.

A control unit 130 is provided for controlling the individual light-emitting diodes 110, and, optionally, the active cooling devices 121 and 122. In particular, the control unit 130 may, respectively, jointly control the light-emitting diodes of each group 111 and 112.

The light-emitting diodes 110 are, in particular, of the same type, and each emit emission light in the same wavelength range—for example, violet light in a wavelength range between 380 nm and 390 nm.

The microscope illumination device 100 furthermore has a light conversion element 140. The light conversion element 140 is designed as an optical waveguide which contains different fluorescent materials 151 through 157 having different respective emission ranges.

The optical waveguide is preferably designed as a transparent solid and is manufactured from, for example, acrylic glass (polymethyl methacrylate, PMMA). The fluorescent materials 151 through 157 may have been permanently incorporated into the acrylic glass in a manufacturing process. For example, the individual fluorescent materials 151 through 157 may each be introduced into the acrylic glass as quantum dots made of semiconductor materials.

These different fluorescent materials 151 through 157 may each have a similar excitation range—for example, respectively between 350 nm and 450 nm. However, each of the fluorescent materials 151 through 157 has an individual emission range.

For example, the material 151 may have an emission range between 400 nm and 500 nm, with a center wavelength of 450 nm. For example, the material 152 has an emission range between 440 nm and 540 nm, with a center wavelength of 490 nm. The material 153 has an emission range between 475 nm and 575 nm, with a center wavelength of 525 nm. For example, the emission range of the material 154 has a center wavelength of 540 nm and extends between 490 nm and 590 nm. The center wavelength of the emission range of the material 155 is at 575 nm, for example, and the range extends between 525 nm and 625 nm. The material 156 has an emission range between 580 nm and 680 nm, with a center wavelength of 630 nm, and the material 157 has an emission range between 615 nm and 715 nm, with a center wavelength of 665 nm.

The groups of light sources 111 and 112 are respectively arranged on opposite sides of the light conversion element 140. Emission light of the light sources 110 may thus be coupled into the light conversion element 140 in a simple manner.

In the light conversion element 140, the light of the light sources 110 is absorbed by the different fluorescent materials 151 through 157. After this excitation, the fluorescent materials 151 through 157 each emit emission light in the respective emission ranges.

This light emitted from the materials 151 through 157 is transported in the light conversion element 140 to its ends 141 and 142 via total reflection. A reflective element 143 in the form of a reflection coating is affixed to one end 141 of the light conversion element 140. The emission light of the materials 151 through 157 that impinges there is reflected at the reflection coating 143 and is thereupon guided to the other end 142 of the light conversion element 140.

This end 142 of the light conversion element 140 is to be regarded as a light exit face, at which the light emitted by the fluorescent materials 151 through 157 is decoupled.

For more efficient decoupling of the illumination light, a light-emitting element, e.g., in the form of an anti-reflection coating 144, may be affixed at the light exit face 142. Furthermore, an additional light-emitting element may be mounted at the light exit face 142—for example, in the form of a parabolic concentrator 145 or a gradient index lens 146.

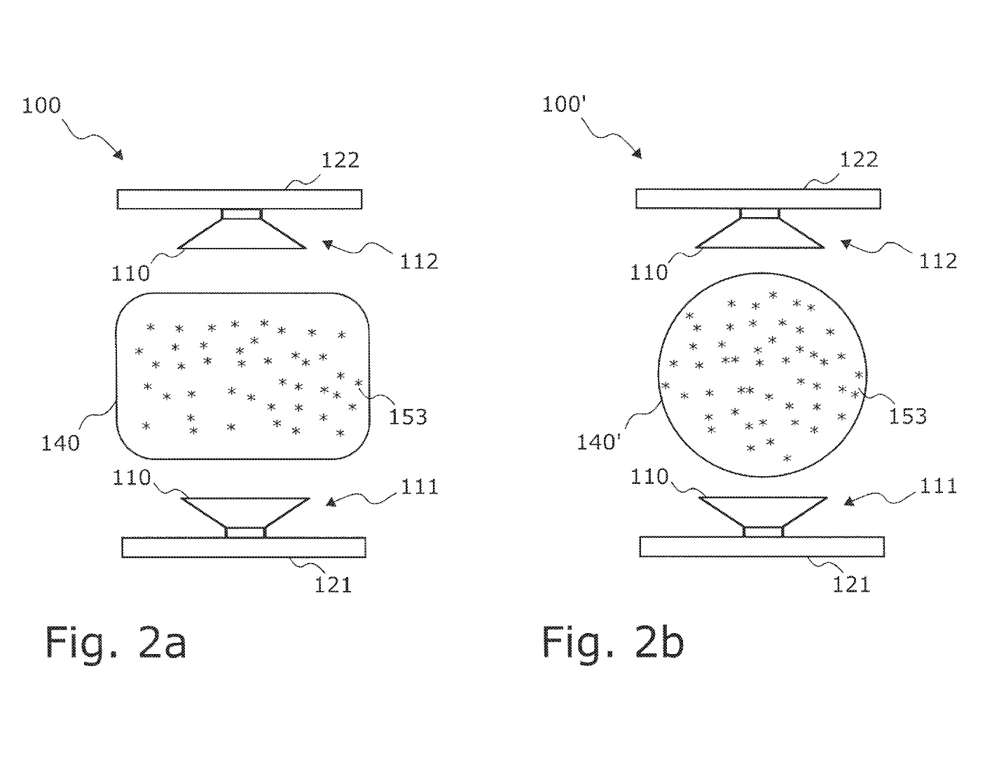

A cross-section through the microscope illumination device 100 along the line A-A is shown schematically in FIG. 2a. As can be seen in FIG. 2a, the light conversion element 140 has a cross-sectional area in the form of a rectangle with rounded corners. The two groups 111 and 112 of light-emitting diodes are arranged on opposite sides of the cross-sectional area.

In FIG. 2b, a cross-section through a preferred embodiment of a microscope illumination device 100′ according to the invention, analogous to FIG. 2a, is shown. This microscope illumination device 100′ has a light conversion element 140′ which has a circular cross-sectional area.

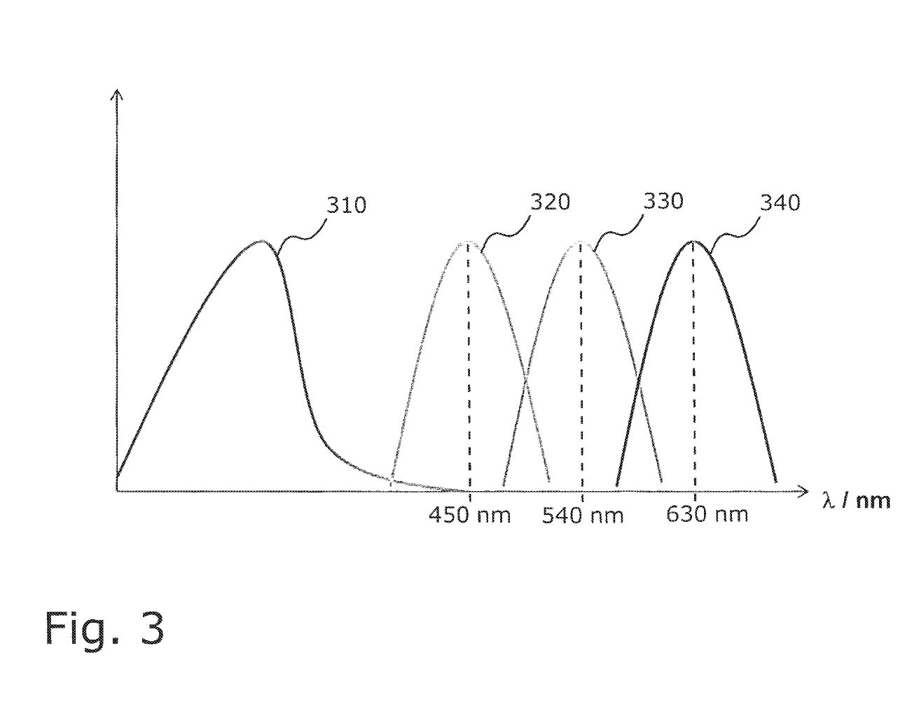

Schematically shown in FIG. 3 are schematic spectra of the fluorescent materials of the light conversion element from FIG. 1. The wavelength is thereby indicated in nm on the abscissa.

The curve labeled as 310 thereby characterizes the excitation range of the fluorescent materials 151 through 157. Furthermore, three emission spectra are shown in FIG. 3, e.g., the emission spectrum 320 of the material 151 between 400 nm and 500 nm, with the center wavelength of 450 nm; the emission spectrum 330 of the material 154 between 490 nm and 590 nm, with a center wavelength of 540 nm; and the emission spectrum 340 of the material 156 between 580 nm and 680 nm, with a center wavelength of 630 nm. Since the fluorescent materials are realized as quantum dots, their spectra each have the form of a Lorentz curve.

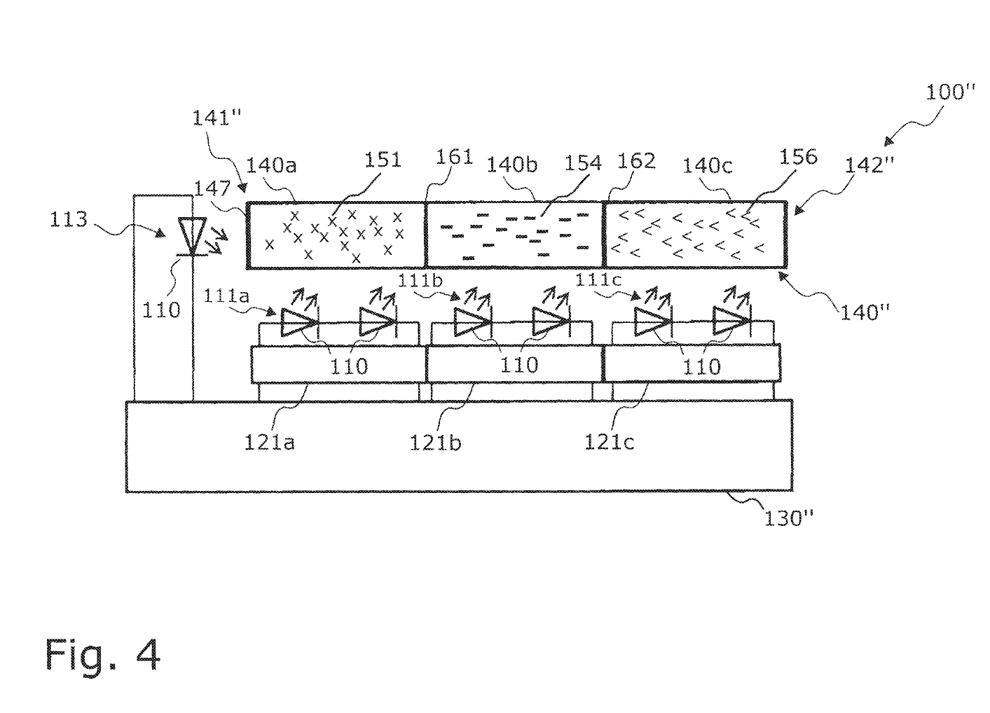

In FIG. 4, a further preferred embodiment of a microscope illumination device according to the invention is depicted in a schematic side view, analogous to FIG. 1, and is designated by 100″.

The microscope illumination device 100″ has a light conversion element 140″ which is subdivided into three segments 140a, 140b, 140c. Illumination light is decoupled at a light exit face 142″ of the light conversion element 140″. Via the three segments 140a, 140b, 140c, flexibly switching individual spectral components of the illumination light on or off is made possible.

Each of these three segments 140a, 140b, 140c respectively contains only one type of fluorescent material. Only the material 151 is introduced into the segment 140a; only the material 154 is introduced into the segment 140b; and only the material 156 is introduced into the segment 140c.

The segments 140a, 140b, 140c may thereby be realized, in that each of the segments 140a, 140b, 140c is formed by a separate optical waveguide, and wherein these three optical waveguides are arranged one after another.

One light source group 111a, 111b, or 111c is respectively provided for each of the three segments 140a, 140b, 140c. In this example, in each of these light source groups 111a, 111b, and 111c, two light-emitting diodes are respectively arranged side-by-side at an active cooling device 121a, 121b, or 121c.

The light source group 111a thereby serves to excite the material 151 in the segment 140a, whereas the light source group 111b serves to excite the material 154 in the segment 140b, and the light source group 111c thereby serves to excite the material 156 in the segment 140c.

A control unit 130″ is provided to control the light source groups 111a, 111b, and 111c, as well as the active cooling devices 121a, 121b, and 121c. Each of the light sources 111a, 111b, and 111c may be activated and deactivated individually and independently of one another by the control unit 130″.

By activating or deactivating a single light source group, the spectral components of the corresponding fluorescent material can be flexibly switched on or off at the illumination light of the respective segment associated with this light source group.

The segments 140a, 140b, 140c are each separated from one another by a separating element 161 or 162, which respectively reflects light in the excitation range of the fluorescent materials. Thus, it may, in particular, be prevented that the material of a segment is excited by the light-emitting diodes of the group of the adjacent segment.

An additional light source group 113 made up of a light-emitting diode is arranged behind the end 141″, situated opposite the light exit face 142″, of the light conversion element 140″. Affixed at this end 141″ is a reflective element 147 in the form of a reflection coating, which, however, is transparent in the emission range of the light-emitting diodes 110. The light of the light-emitting diode 110 of the group 113 may thus be coupled directly into the light conversion element 140″.

Via the three different segments 140a, 140b, and 140c, the fluorescent materials 151, 154, and 156 are arranged in the light conversion element 140″ such that the emission ranges of the fluorescent materials follow a predetermined distribution along a length of the light conversion element in the direction of the light exit face 142″.

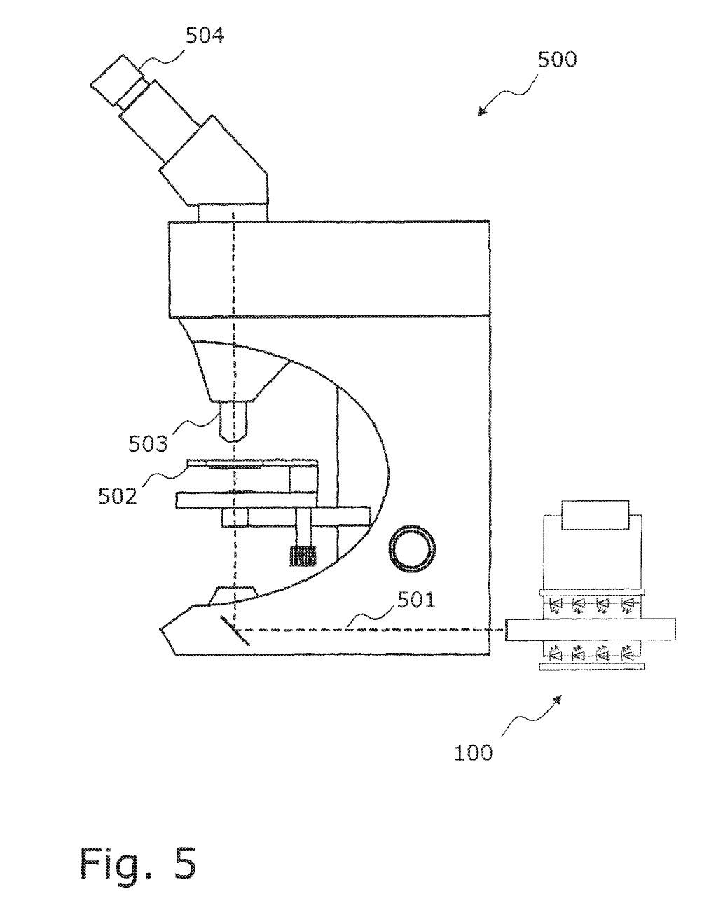

In FIG. 5, a preferred embodiment of a microscope illumination device according to the invention is schematically depicted in a side view and is designated by 500.

The microscope 500 comprises a preferred embodiment of a microscope illumination device according to the invention—for example, the microscope illumination device 100 shown in FIG. 1. Illumination light which is decoupled by the microscope illumination device 100 at the light exit face is coupled into a beam path 501 of the microscope 500. An object 502 to be observed is illuminated by the illumination light. The microscope 500 furthermore has an objective 503 and an eyepiece 504 for observing the object. It is understood that the microscope 500 may have further suitable elements.

The microscope 500 shown in FIG. 5 is designed as a transmitted light microscope, for example, in which the sample is illuminated from below with the illumination light. However, the microscope may also be designed as a reflected light microscope, for example, in which a sample is illuminated from above.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

100 Microscope illumination device
100′ Microscope illumination device
100″ Microscope illumination device
110 Light sources, light-emitting diodes
111 Light source group, light-emitting diodes
111a Light source group, light-emitting diodes
111b Light source group, light-emitting diodes
111c Light source group, light-emitting diodes
112 Light source group, light-emitting diodes
113 Light source group, light-emitting diodes
121 Active cooling device
121a Active cooling device
121b Active cooling device
121c Active cooling device
122 Active cooling device
130 Control unit
130″ Control unit
140 Light conversion element
140′ Light conversion element
140″ Light conversion element
140a Segment of the light conversion element
140b Segment of the light conversion element
140c Segment of the light conversion element
141 End of the light conversion element
141″ End of the light conversion element
142 End of the light conversion element, light exit face
142″ End of the light conversion element, light exit face
143 Reflective element, reflection coating
144 Light-emitting element, anti-reflection coating
145 Light-emitting element, parabolic concentrator
146 Light-emitting element, gradient index lens
147 Reflective element, reflection coating
151 Fluorescent material
152 Fluorescent material
153 Fluorescent material
154 Fluorescent material
155 Fluorescent material
156 Fluorescent material
157 Fluorescent material
161 Separating element
162 Separating element
310 Excitation range
320 Emission spectrum
330 Emission spectrum
340 Emission spectrum
500 Microscope
501 Beam path
502 Sample
503 Objective
504 Eyepiece

1. A microscope illumination device, comprising:
at least one light source; and
a light conversion element configured as at least one optical waveguide which contains different fluorescent materials each having different emission ranges,
wherein the at least one light source is arranged such that emission light for exciting the fluorescent materials from the at least one light source is coupled into the light conversion element, and
wherein the light conversion element is configured such that light emitted by the fluorescent materials is guided to a light exit face of the light conversion element and is decoupled at the light exit face as illumination light.

2. The microscope illumination device according to claim 1, wherein the light conversion element is subdivided into segments, wherein each of the segments respectively contains only one of the fluorescent materials, and/or wherein each of the segments respectively contains fluorescent materials having the same or at least essentially the same emission ranges.

3. The microscope illumination device according to claim 2, wherein the at least one light source has several light sources, wherein respectively at least one of the several light sources is provided for each of the segments.

4. The microscope illumination device according to claim 2, wherein the segments are respectively separated from one another by separating elements which respectively reflect or absorb light at specific wavelengths.

5. The microscope illumination device according to claim 1, wherein the light conversion element is designed as at least one transparent solid that contains the different fluorescent materials.

6. The microscope illumination device according to claim 1, wherein the different fluorescent materials comprise quantum dots.

7. The microscope illumination device according to claim 1, wherein the emission light of the at least one light source has shorter wavelengths than the light emitted by the fluorescent materials.

8. The microscope illumination device according to claim 1, wherein the emission light of the at least one light source has wavelengths between 350 nm and 450 nm.

9. The microscope illumination device according to claim 1, wherein the different emission ranges of the different fluorescent materials are at wavelengths between 400 nm and 700 nm.

10. The microscope illumination device according to claim 1, wherein the fluorescent materials are arranged in the light conversion element such that a density and/or the emission ranges and/or excitation ranges of the fluorescent materials follow a predetermined distribution along a length of the light conversion elements in a direction of the light exit face.

11. Microscope illumination device according to claim 1, further comprising a reflective element arranged at an end of the light conversion element opposite to the light exit face.

12. The microscope illumination device according to claim 1, further comprising a light-emitting element arranged at the light exit face of the light conversion element.

13. A microscope comprising the microscope illumination device according to claim 1.

14. The microscope illumination device according to claim 1, wherein the different emission ranges of the different fluorescent materials are at wavelengths between 450 nm and 670 nm.
